(19) United States
(12) Patent Application Publication
(10) Pub. No.: US 2022/0142116 A1
(43) Pub. Date: May 12, 2022

(54) TOILET

(71) Applicant: DAIKI CO., LTD., Tokyo (JP)

(72) Inventor: Junji YOSHINAGA, Tokyo (JP)

(73) Assignee: DAIKI CO., LTD., Tokyo (JP)

(21) Appl. No.: 17/584,678

(22) Filed: Jan. 26, 2022

Related U.S. Application Data
(63) Continuation of application No. PCT/JP2020/029868, filed on Aug. 4, 2020.

(30) Foreign Application Priority Data
Oct. 16, 2019 (JP) 2019-189138

(51) Int. Cl. A01K 1/015; A01K 1/01

(52) U.S. Cl. CPC A01K 1/0155; A01K 1/0114

(57) ABSTRACT

A toilet includes a body portion, a plurality of grains, and a light source. The body portion has a bottom face part and a side face part, and is in a box shape. The plurality of grains are disposed in the body portion. The grains have a water-repellent property. The light source irradiates the plurality of grains disposed in the body portion with light. At least a part of the plurality of grains contain a coloring material that discolors gradually when receiving the light, and exhibit a first color before start of use and exhibit a second color in replacement timing of the grains, the second color being different from the first color.

### CROSS REFERENCE TO RELATED APPLICATION

This is a Continuation of International Application No. PCT/JP2020/029868 filed Aug. 4, 2020, which claims the benefit of Japanese Application No. 2019-189138 filed Oct. 16, 2019. The contents of these applications are hereby incorporated by reference in their entirety.

### TECHNICAL FIELD

The present invention relates to a toilet for animals or humans.

### BACKGROUND ART

A conventional toilet is disclosed in, for example, Patent Document 1. The toilet disclosed in Patent Document 1 is a toilet for animals, and is divided into an upper space and a lower space by a mesh sheet that allows urine to pass therethrough. A plurality of water-repellent grains are disposed in the upper space. A liquid-absorbing sheet is disposed in the lower space. When an animal urinates, the urine passes through gaps between the water-repellent grains, and arrives in the lower space through the mesh sheet. The urine having arrived in the lower space is absorbed by the liquid-absorbing sheet.

### CITATION LIST

### Patent Document

Patent Document 1: JP 2005-110700 A

### SUMMARY OF INVENTION

### Technical Problem

The water-repellent grains absorb urine not at all or almost not at all, and therefore are capable of being used repeatedly over a considerable period (e.g. one to two months), unlike water-absorbing grains In this way, the water-repellent grains are advantageous in that the replacement frequency is markedly lower than the water-absorbing grains, which need to be replaced after every use generally. However, on the other hand, there is a problem that users are likely to miss the replacement timing of the grains due to the replacement frequency being low. Missing the replacement timing may cause an adverse effect such as collapse of the grains or generation of odors.

### Solution to Problem

The present invention has been made in view of the above-described problem, and it is an object thereof to provide a toilet in which the replacement timing of grains is easy to grasp.

A toilet according to the present invention includes: a box-shaped body portion having a bottom face part and a side face part; a plurality of grains that have a water-repellent property and are disposed in the body portion; and a light source that irradiates the plurality of grains disposed in the body portion with light. At least a part of the plurality of grains contain a coloring material that discolors gradually when receiving the light, and exhibit a first color before start of use and exhibit a second color in replacement timing of the grains, the second color being different from the first color.

This toilet is provided with the light source that irradiates the plurality of grains with light. At least a part of the plurality of grains contain the coloring material that discolors gradually when receiving the light. The grains exhibit the different color (second color) from the color before start of use (first color) when the replacement timing comes. For this reason, the users can grasp the replacement timing by change in color of the grains.

### Advantageous Effects of Invention

According to the present invention, it is possible to implement a toilet in which the replacement timing of grains is easy to grasp.

### BRIEF DESCRIPTION OF DRAWINGS

FIG. 1 is an end view showing an embodiment of a toilet according to the present invention.

FIG. 2 is an end view showing a body portion 10.

FIG. 3 is a front view showing the body portion 10.

FIG. 4 is a plan view showing a partition member 12.

FIG. 5 is a perspective view showing a drawer portion 14.

FIG. 6 is a plan view showing a toilet 1.

FIG. 7 is a schematic view showing a grain 20.

### DESCRIPTION OF EMBODIMENTS

Hereinafter, an embodiment of the present invention will be described in detail with reference to the drawings. In the description of the drawings, the same elements are given the same reference numerals, and a redundant description will be omitted.

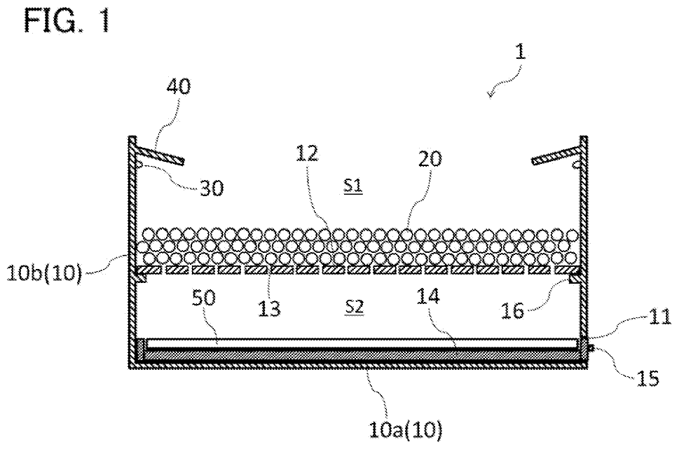

FIG. 1 is an end view showing an embodiment of a toilet according to the present invention. A toilet 1 is a toilet for animals or humans, and includes a body portion 10, a partition member 12, a drawer portion 14, a plurality of grains 20, a light source 30, a cover member 40, and a water-absorbing sheet 50. The body portion 10 has a bottom face part 10a and a side face part 10b, and is in a box shape. In the present embodiment, the body portion 10 is in an approximately rectangular parallelepiped shape. As a material of the body portion 10, for example, a resin such as polypropylene or polyethylene can be used.

The partition member 12 is in a plate shape, and arranged in parallel with the bottom face part 10a. The partition member 12 is provided at a position apart from both the water-absorbing sheet 50 described later and the upper end of the body portion 10. Thus, the partition member 12 divides the inside of the body portion 10 vertically. That is, the internal space of the body portion 10 is divided into an upper space S1 and a lower space S2 by the partition member 12. The partition member 12 has a hole 13 that allows urine to pass through the hole 13. The partition member 12 is detachable relative to the body portion 10. As a material of the partition member 12, for example, a resin such as polypropylene or polyethylene can be used.

A projecting part 16 that projects from the inner surface of the side face part 10b toward the inside of the body portion 10 is formed on the inner surface. The projecting part 16 may be a projection or a projected rim. The projecting part 16 may be formed integrally with the side face part 10b, or may be attached to the side face part 10b after being formed separately from the side face part 10b. The projection length of the projecting part 16 (the length in the direction perpendicular to the inner surface of the side face part 10b provided with the projecting part 16) is, for example, about 5 to 15 mm. The partition member 12 is fixed at the predetermined position by being placed on the projecting part 16.

The drawer portion 14 is capable of being inserted in and extracted from the body portion 10 through an opening 11 formed in the side face part 10b. The drawer portion 14 houses the water-absorbing sheet 50. As a material of the drawer portion 14, for example, a resin such as polypropylene or polyethylene can be used.

The plurality of grains 20 are disposed in the body portion 10. In the present embodiment, the grains 20 are disposed in the body portion 10 in a state of being laid on the partition member 12. When the toilet 1 is used, the grains 20 directly receive excreted urine. The grains 20 have a water-repellent property. That is, the grains 20 have the property of not absorbing liquid such as urine at all, or hardly absorbing it.

The grains 20 having the water-repellent property require the water-repellent rate of 80% or more measured by the following test. First, approximate 50 grams of a plurality of the grains 20 (sample) are placed in a strainer. An empty beaker is set under the strainer. Then, 30 ml of water is dripped on the sample over 10 seconds using a syringe without a needle. After waiting 1 minute, the quantity of the water in the beaker is measured. The ratio of the measured water quantity with respect to the quantity of the dripped water (30 ml) shall be the water-repellent rate. That is, if the water quantity in the beaker is 24 ml or more, the water-repellent rate is 80% or more, and therefore the grains 20 are found to have the water-repellent property. For reference, the water-repellent rate of general water-absorbing cat litter, which is commercially available, is about 5%.

The light source 30 irradiates the plurality of grains 20 disposed in the body portion 10 with light. The light source 30 is fixed to the side face part 10b. The light source 30 is attached at a higher position than the grains 20 laid on the partition member 12. The light source 30 is preferably a light emitting diode (LED). The light emitted by the light source 30 may be visible light or ultraviolet light. The light source 30 may be kept on at all times, or may be switched on and off repeatedly at predetermined time intervals. In the latter case, for example, the light source 30 can be controlled so as to be kept on only 8 hours a day. A control circuit, wirings, and so forth (not shown in the figures) of the light source 30 can be, for example, provided in the interior of the side face part 10b that has been made hollow.

The cover member 40 is provided so as to protrude from the side face part 10b toward the inside of the body portion 10. The cover member 40 may be formed integrally with the side face part 10b, or may be attached to the side face part 10b after being formed separately from the side face part 10b. The protrusion length of the cover member 40 (the length in the direction perpendicular to the inner surface of the side face part 10b provided with the cover member 40) is, for example, about 3 to 7 cm. The cover member 40 covers the light source 30 from above. The cover member 40 is in a plate shape. The base of the cover member 40 is a fixed end that is connected to the side face part 10b, whereas the tip of the cover member 40 is a free end that is located in the internal space (the upper space S1) of the body portion 10. The cover member 40 inclines downward toward the inside of the body portion 10. As a material of the cover member 40, for example, a resin such as polypropylene or polyethylene can be used.

The water-absorbing sheet 50 is disposed in the body portion 10. In the present embodiment, the water-absorbing sheet 50 is disposed in the body portion 10 in a state of being housed in the drawer portion 14. The water-absorbing sheet 50 absorbs urine that has passed through the hole 13 of the partition member 12.

When the toilet 1 is used, urine excreted on the grains 20 flows downward while winding its way through gaps between the adjacent grains 20. The urine moves from the upper space S1 to the lower space S2 through the hole 13 of the partition member 12, and then is absorbed by the water absorbing sheet 50.

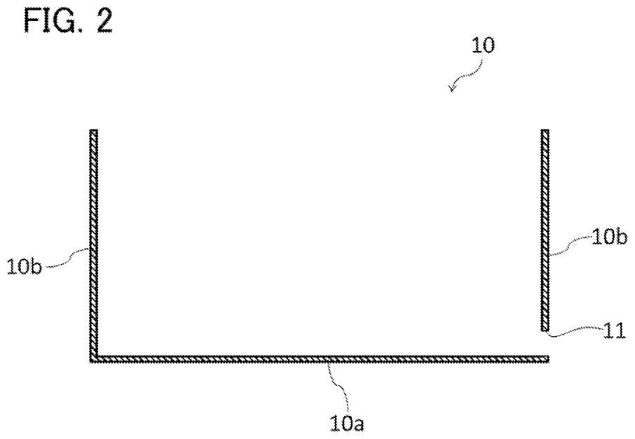

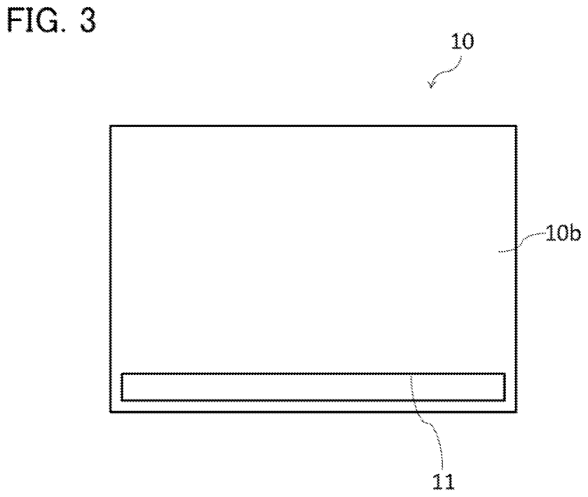

FIG. 2 and FIG. 3 are, respectively, an end view and a front view showing the body portion 10. The opening 11 for inserting and extracting the drawer portion 14 is formed in the side face part 10b of the body portion 10. The opening 11 is located near the bottom face part 10a, and in a horizontally long rectangular shape. The length in the horizontal direction (right/left direction in FIG. 3) of the opening 11 is nearly equal to the breadth of the inside of the body portion 10, and is, for example, about 20 to 40 cm. Also, the length in the vertical direction (top/bottom direction in FIG. 3) of the opening 11 is, for example, about 2 to 5 cm.

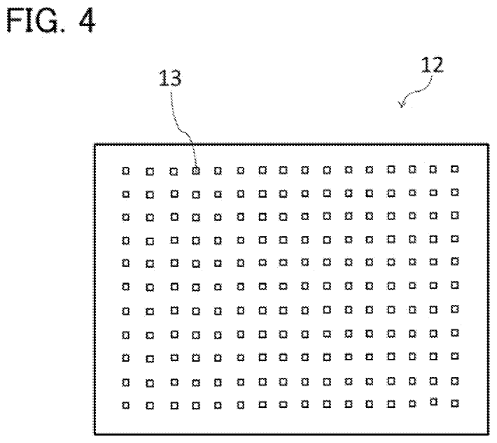

FIG. 4 is a plan view showing the partition member 12. A plurality of the holes 13 are formed in the partition member 12. The holes 13 are arranged two-dimensionally in the partition member 12. The holes 13 allow urine to pass therethrough. However, the holes 13 do not allow the grain 20 to pass therethrough. That is, the holes 13 each have such a size and shape that urine can pass through the hole 13 whereas the grain 20 cannot pass through the hole 13. The diameter of the hole 13 is, for example, about 2 to 4 mm.

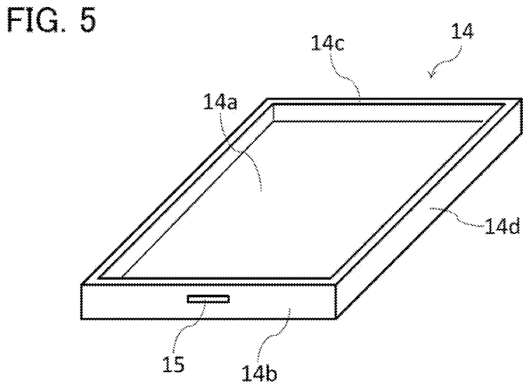

FIG. 5 is a perspective view showing the drawer portion 14. The drawer portion 14 has a bottom board 14a, a front board 14b, a rear board 14c, and a pair of side boards 14d. The size of the bottom board 14a is nearly equal to the size of the bottom face part 10a of the body portion 10. The front board 14b has nearly the same shape and size as the opening 11. A grip 15 is attached to the front board 14b.

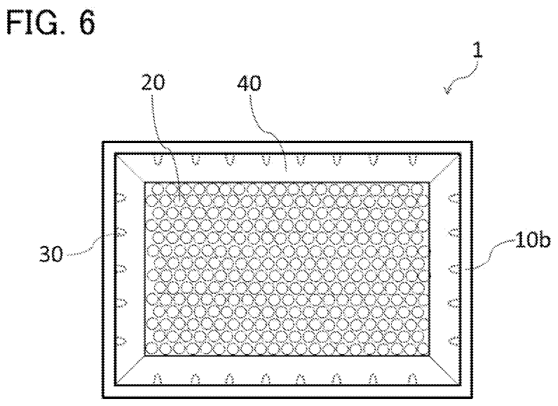

FIG. 6 is a plan view showing the toilet 1. The toilet 1 is provided with a plurality of the light sources 30. As can be seen from FIG. 6, the plurality of light sources 30 are arranged annularly along the inner surface of the side face part 10b in plan view. Also, the cover member 40 is provided over the entire inner surface of the side face part 10b in plan view.

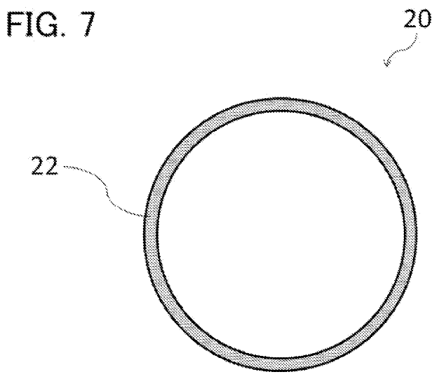

FIG. 7 is a schematic view showing the grain 20. The grain 20 is formed in a granular shape. Examples of the granular shape include a sphere, column, and ellipsoid. The particle diameter of the grain 20 is, for example, about 5 to 15 mm. As used herein, the particle diameter is defined as the diameter of the minimum sphere that can include the grain 20. The grain 20 preferably contains an organic substance as its main material. As used herein, the main material refers to the material that accounts for the highest weight ratio in the grain 20, out of one or more materials constituting the grain 20. As the organic substance, for example, papers, used tea leaves, plastics, or bean curd lees can be used.

The papers refer to a material composed mainly of pulp. Examples of the papers include, in addition to ordinary paper, a vinyl chloride wallpaper classified product (paper obtained by classifying vinyl chloride wallpaper), fluff pulp, papermaking sludge, and pulp sludge. As the plastics, for example, a disposable diaper classified product (plastic obtained by classifying disposable diapers) may be used. The bean curd lees are preferably dried bean curd lees. These materials may be subjected to water repellency treatment.

The material(s) (except a coloring material 22 described later) constituting the grain 20 may be only one material, or two or more materials. In the former case, the main material described above is the only material constituting the grain 20. In the latter case, the grain 20 is made of a mixture of the main material and other material(s). Gypsum is an example of the other material. Adding gypsum can enhance the water-repellent property of the grain 20. The quantity of gypsum is, for example, about 5 to 15 wt % with respect to the entirety of the grain 20.

The grain 20 contains the coloring material 22. The coloring material 22 discolors gradually when receiving the light from the light source 30. As the coloring material 22, for example, a coloring material that discolors by fading gradually when receiving light can be used. The coloring material 22 is preferably yellow or red. Also, the coloring material 22 is preferably made of natural pigment. Examples of the natural pigment include anthocyanin pigment, carotenoid pigment, and flavonoid pigment.

The coloring material 22 is exposed on the surface of the grain 20. The coloring material 22 may be provided only in the surface layer of the grain 20, or may be provided uniformly in the entirety of the grain 20. That is, it is sufficient that at least a part of the coloring material 22 is exposed on the surface of the grain 20. FIG. 7 shows the case where the coloring material 22 is provided only in the surface layer of the grain 20. The coloring material 22 may be contained in all of the plurality of grains 20, or may be contained only in a part of the plurality of grains 20. That is, it is sufficient that at least a part of the plurality of grains 20 contain the coloring material 22.

The grain 20 containing the coloring material 22 exhibits a first color before start of use and exhibits a second color in the replacement timing of the grain 20 due to the coloring material 22 discoloring. The second color is different from the first color. However, the first color and the second color need not have mutually different hues. For example, the colors may be distinguished by shades of the same hue, such as a case where the first color is dark yellow and the second color is light yellow. A color scale showing the change from the first color to the second color may be annexed to the toilet 1 in order for the users to easily judge whether the grain 20 has changed to the second color.

The grains 20 can be manufactured by, for example, the following method. First, granules that will serve as the grains 20 are formed by granulating a granulating material (the material(s) constituting the grains 20) with a granulation apparatus. As the granulation apparatus, for example, an extrusion granulator can be used. The granules may be subjected to water repellency treatment as needed. The water repellency treatment can be performed by, for example, coating the surfaces of the granules with a water repellent agent. In the case where the water repellency treatment is not performed, it is preferable that crevices are prevented from forming in the granules as much as possible by increasing the pressure that is applied to the granulating material during granulation. This is because the crevices serve as a path through which moisture such as urine enters into the grains 20. Prior to the granulation, pretreatment such as pulverization, kneading, and adding water is performed on the granulating material as needed.

The grains 20 are formed so as to exhibit the first color before start of use and exhibit the second color in the replacement timing of the grains 20. In this example, the grains 20 are formed such that the coloring material 22 is exposed on the surfaces of the grains 20. The grains 20 configured in this way can be formed by, for example, attaching the coloring material 22 to the surfaces of the above-described granules. Specifically, the coloring material 22 can be attached to the surfaces of the granules by, for example, mixing an adhesive with the powdery coloring material 22, and then applying the mixture to the surfaces. Thus, the grains 20 are obtained in which the coloring material 22 is provided only in the surface layer. Note that the water repellency treatment described above may be performed after the coloring material 22 is attached to the surfaces of the granules. On the other hand, in a case where the grains 20 are desired in which the coloring material 22 is provided uniformly in the entirety, the coloring material 22 can be added in advance and kneaded before granulating the granulating material.

The grains 20 can be adjusted so as to exhibit the second color in the replacement timing (e.g. one to two months from start of use) of the grains 20 by a type of the coloring material 22, a wavelength of the light from the light source 30, intensity of the light, and so forth. Note that it is difficult to precisely control the timing of color change to the second color because lighting in the room or the like has an influence on color change of the coloring material 22. However, a standard use environment (a room of an ordinary home) of the toilet 1 can be assumed, and therefore it is possible to roughly control the timing of color change to the second color by conducting a simple experiment under that assumption. For example, even if it is difficult to control the change in color such that the color changes to the second color when exactly one month has passed since the start of use, it is easy to control the change in color such that the color changes to the second color within one to two months from the start of use.

The effects of the present embodiment will be described. The toilet 1 is provided with the light source 30 that irradiates the plurality of grains 20 with light. At least a part of the plurality of grains 20 contain the coloring material 22 that discolors gradually when receiving the light. The grains 20 containing the coloring material 22 exhibit the different color (second color) from the color before start of use (first color) when the replacement timing comes. For this reason, the users can grasp the replacement timing by change in color of the grains 20. Accordingly, the toilet 1 in which the replacement timing of the grains 20 is easy to grasp is implemented.

The coloring material 22 is exposed on the surface of the grain 20. Thus, it becomes easier for the users to visually recognize the change from the first color to the second color.

The coloring material 22 discolors by fading gradually when receiving the light from the light source 30. In this case, because the color gradually fades away from the grains 20, there is an advantage that it is easy for the users to intuitively recognize the fact that the replacement timing of the grains 20 is approaching.

In the case where the coloring material 22 is yellow or red, because these colors fade easily, the change from the first color to the second color can be enlarged. Thus, it becomes easier for the users to visually recognize the change from the first color to the second color.

In the case where the coloring material 22 is made of natural pigment, because the natural pigment fades more easily than synthetic pigment, the change from the first color to the second color can be enlarged. However, the coloring material 22 may be made of synthetic pigment.

In the case where the coloring material 22 is contained only in a part of the plurality of grains 20, it is possible to save the amount of the coloring material 22 used, compared to the case where the coloring material 22 is contained in all of the grains 20.

In the case where the light source 30 is a light emitting diode, it is possible to suppress power consumption and heat generation of the light source 30.

In the case where the light from the light source 30 is visible light, it is possible to enhance safety when the light is received by animals or humans.

In the case where the light from the light source 30 is ultraviolet light, because the ultraviolet light has higher energy than visible light, there is an advantage that the grains 20 fade easily. Thus, the change from the first color to the second color can be enlarged.

The toilet 1 is provided with the plurality of light sources 30. Thus, it becomes easier to evenly irradiate the plurality of grains 20 disposed in the body portion 10 widely with light, compared to the case where only one light source 30 is provided. However, the toilet 1 may be provided with only one light source 30.

The toilet 1 is provided with the cover member 40 that covers the light source 30 from above. Thus, the light source 30 can become less likely to be spattered with excrement. Moreover, the light from the light source 30 can become less likely to directly enter the eyes of animals or humans.

The cover member 40 inclines downward toward the inside of the body portion 10. Thus, even when urine is excreted on the cover member 40, the urine flows down from the tip of the cover member 40 along the inclination. For this reason, the urine can be prevented from accumulating on the upper surface of the cover member 40.

The inside of the body portion 10 is divided vertically by the partition member 12, and the plurality of grains 20 are disposed on the partition member 12. Thus, it is possible to separate the space (upper space S1) in which the grains 20 are disposed and the space (lower space S2) in which urine accumulates. For this reason, the grains 20 can be prevented from coming in contact with urine accumulating in the body portion 10 (including urine absorbed by the water-absorbing sheet 50).

The water-absorbing sheet 50 is disposed below the partition member 12. Thus, the urine accumulating in the body portion 10 can be confined in the water-absorbing sheet 50. For this reason, it is possible to reduce generation of odors caused by the urine accumulating in the body portion 10.

The toilet 1 is provided with the drawer portion 14 that is capable of being inserted in and extracted from the body portion 10. Thus, used water-absorbing sheet 50 can be easily replaced with a new one.

The present invention is not limited to the above-described embodiment, and various modifications can be made. In the above-described embodiment, an example is given in which the light source 30 is fixed to the side face part 10b. However, the light source 30 may be fixed to the lower surface of the cover member 40.

In the above-described embodiment, an example is given in which the cover member 40 inclines. However, the cover member 40 may be provided horizontally, namely in parallel with the bottom face part 10a without inclining. Note that it is not essential to provide the cover member 40.

In the above-described embodiment, an example is given in which the partition member 12 is provided. However, it is not essential to provide the partition member 12. In the case where the partition member 12 is not provided, the grains 20 are laid directly on the water-absorbing sheet 50.

In the above-described embodiment, an example is given in which the drawer portion 14 is provided. However, it is not essential to provide the drawer portion 14. In the case where the drawer portion 14 is not provided, the water-absorbing sheet 50 is disposed directly on the bottom face part 10a. In that case, the side face part 10b is not provided with the opening 11 naturally.

In the above-described embodiment, an example is given in which the water-absorbing sheet 50 is disposed in the body portion 10. However, it is not essential to dispose the water-absorbing sheet 50 in the body portion 10. In the case where the water-absorbing sheet 50 is not disposed, the drawer portion 14 is also not provided. Note that the grains 20 are laid directly on the bottom face part 10a in the case where none of the partition member 12, the drawer portion 14 and the water-absorbing sheet 50 is provided.

### LIST OF REFERENCE NUMERALS

1 Toilet

10 Body Portion

10a Bottom Face Part

10b Side Face Part

11 Opening

12 Partition Member

13 Hole

14 Drawer Portion

15 Grip

16 Projecting Part

20 Grain

22 Coloring Material

30 Light Source

40 Cover Member

50 Water-Absorbing Sheet

1. A toilet comprising:
a box-shaped body portion having a bottom face part and a side face part;
a plurality of grains that have a water-repellent property and are disposed in the body portion; and
a light source that irradiates the plurality of grains disposed in the body portion with light,
wherein at least a part of the plurality of grains contain a coloring material that discolors gradually when receiving the light, and exhibit a first color before start of use and exhibit a second color in replacement timing of the grains, the second color being different from the first color.

2. The toilet according to claim 1,
wherein the coloring material is exposed on a surface of the grain containing the coloring material.

3. The toilet according to claim 1,
wherein the coloring material discolors by fading gradually when receiving the light.

4. The toilet according to claim 3,
wherein the coloring material is yellow or red.

5. The toilet according to claim 1,
wherein the coloring material is made of natural pigment.

6. The toilet according to claim 5,
wherein the natural pigment is anthocyanin pigment, carotenoid pigment, or flavonoid pigment.

7. The toilet according to claim 1,
wherein the coloring material is contained only in a part of the plurality of grains.

8. The toilet according to claim 1,
wherein the light source is a light emitting diode.

9. The toilet according to claim 1,
wherein the light is visible light.

10. The toilet according to claim 1,
wherein the light is ultraviolet light.

11. The toilet according to claim 1, further comprising:
a plurality of the light sources.

12. The toilet according to claim 1, further comprising:
a cover member that is provided so as to protrude from the side face part toward an inside of the body portion, and covers the light source from above.

13. The toilet according to claim 12,
wherein the cover member inclines downward toward the inside of the body portion.

14. The toilet according to claim 1, further comprising:
a partition member that has a hole allowing urine to pass therethrough, and divides an inside of the body portion vertically,
wherein the plurality of grains are laid on the partition member.

15. The toilet according to claim 14, further comprising:
a water-absorbing sheet that is disposed below the partition member, and absorbs the urine having passed through the hole.

16. The toilet according to claim 15, further comprising:
a drawer portion that houses the water-absorbing sheet,
wherein an opening is formed in the side face part of the body portion, and
the drawer portion is capable of being inserted in and extracted from the body portion through the opening.
